(19) United States
(12) Patent Application Publication
(10) Pub. No.: US 2006/0020501 A1
(43) Pub. Date: Jan. 26, 2006

(54) Benefit plans

(76) Inventors: Howard Jay Leicht, Needham, MA (US); Caroline Foster Willmuth, Holden, MA (US); Glenn G. Johnson, North Kingston, RI (US); Vanessa Govindasamy Govender, Sutton, MA (US); Rachael Anne Cooksey, Northborough, MA (US); John Morrison Greene, Randolph, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/896,706

(22) Filed: Jul. 22, 2004

(51) Int. Cl. G06Q 99/00

(52) U.S. Cl. 705/8; 705/1

(57) ABSTRACT

A computerized system for dynamically generating an on-line questionnaire for collecting operational parameters of an employee benefit plan includes a component development module for developing application components with multiple attributes, a subset of which collectively effect the functionality of other components, a business rule parser for translating business rules into executable software code describing the effects of the components on each other, an application definition module for creating an on-line questionnaire definition relating to the operational parameters of the employee benefit plan using the components and a compiler for dynamically generating the questionnaire based on the components and the executable software code.

### TECHNICAL FIELD

The invention generally relates to collecting operational parameters of benefit plans such as employee benefit plans.

### BACKGROUND INFORMATION

To maintain a high quality of life after retirement, individuals depend on numerous sources of post-retirement income. In the past, American workers often relied on an employer funded retirement plan (such as a pension plan) and Social Security as the primary sources of retirement income. However, many companies no longer offer pension plans to their employees, and those that do may not have the capabilities to perform the record-keeping functions necessary to administer the plans. Furthermore, most individuals recognize that Social Security is not sufficient as a primary source of post-retirement income, and many even doubt its long-term financial viability. To supplement these two sources of income, many employees participate in so-called “defined contribution plans” such as 401(k) plans, 403(b) plans, or stock purchase plans—which are offered to the employees by their employer as part of an employee benefit package. Further, because of the complex statutory regulations and significant data processing requirements to administer the plans, many plan sponsors outsource the record-keeping functions to a financial services company or data processing company.

Many record-keeping firms also provide similar data processing and record-keeping functions to support more traditional employee benefit plans such as healthcare, life insurance, and payroll processing. Because the data needed to support these more traditional plans (e.g., employee rosters, addresses, beneficiaries, tax information, and marital status) is also needed to administer defined contribution plans, plan sponsors can often recognize significant economic efficiencies by using a single record-keeping firm to administer all of its employee-related benefit plans.

Large companies generally have locations in numerous states and countries, with a diverse employee base that often includes highly-compensated professionals, union members, contract workers, and foreign nationals. Such companies sometimes offer its employees a selection of healthcare plans, often offering different options at different locations, as well as a wide variety of compensation packages depending on local tax laws, labor market customs, negotiated union contracts, etc. As the number of variables increases, the number of possible permutations that any one employee might participate in becomes very high. Thus, the initial setup of the plans (such as capturing the employee data, gathering and entering the operational parameters of the plans, and other tasks) can be lengthy and expensive.

Some previous attempts to address the process of implementing benefit plans used software applications that contemplated some number of permutations and therefore were only able to address certain options that an implementation analyst may have encountered during the implementation process. As a result, changes to business rules or regulations often times necessitated lengthy and expensive modifications by programmers and other information technology professionals. Furthermore, the software applications often presented the implementation analysts with input forms and questions that were not necessarily applicable to the particular plan being implemented, and neglected to present others that were. Although some of these software applications may be able to base some presentations of questions and/or answer sets on previously answered questions, the applications generally lack the ability to quickly build input forms based on real-time data entry consisting of multiple answers provided to individual questions.

### SUMMARY OF THE INVENTION

Tools which can assist plan record keepers to quickly and accurately setup the plan parameters, modify the plan parameters, and convert existing data into their own record-keeping systems provide significant savings to the record-keeping firms. These benefits may in turn be passed on to plan sponsors and their employees. The invention relates to facilitating the rapid development and customization of an application for capturing the data necessary to implement and audit the operational parameters of employee benefit plans. More particularly, the invention relates to a menu-driven application customization tool with which users can create and modify components of a plan implementation application using a simple rules language. Thus, any new or unique parameters, dependencies, or business rules that are necessary to support the implementation of a plan can be quickly incorporated into the plan implementation application using the application customization tool.

Such a tool allows business analysts and plan implementation specialists, who generally do not have the ability to program computer applications or debug software code, to implement customized versions of employee benefit plans. The tools facilitate the quick and accurate entry of the operational parameters of benefit plans, the implementation of enhancements to current plans, and the auditing of plans at any point during or after the implementation process.

To streamline the implementation process, users such as business analysts and implementation specialists create business rules that codify dependencies among questions. Thus, a particular answer to one question may render a subsequent question or an entire set of questions moot, or in some cases limit the list of acceptable answers. In some cases, a question may allow for multiple answers in a list or tabular format and attributes of subsequent questions may depend on the collective set of answers to a particular question. Questions can then be grouped and ordered using other application components such as menus, screens, tables, and implementation stages to coincide with a preferred implementation process.

While particularly useful for employee benefit plans, such as pension plans, medical plans, as well as other benefit plans offered to employees, these methods and tools are not limited to those specific applications, and can be used to design and implement data gathering applications for a wide range of industries such as medical diagnosis, legal proceedings, tax preparation, as well as others.

In one aspect, the invention relates to a computerized system for dynamically generating an on-line questionnaire for collecting operational parameters of an employee benefit plan. The system includes a component development module for developing application components having multiple attributes, a subset of which collectively effect the functionality of other application components. The system also includes a business rule parser for translating business rules into executable software code, which may be written, for example, in javascript, that describes the collective effects of the application components on each other. The system further includes an application definition module for creating an on-line questionnaire definition relating to the operational parameters of an employee benefit plan using the application components and a compiler for dynamically generating the questionnaire based on the questionnaire definition and the executable software code.

The application components can be input forms, menu items, implementation stages, templates, tables, questions, system locations, or answer sets. An application component can include one or more other components. A system location can include instructions for performing a data processing task. The multiple attributes can be multiple answers to a single question. The multiple answers can render other application components non-functional, and where the other application components are questions, the collective effect of the multiple answers can define one or more permissible answers to the questions. Defining the permissible answers to the questions can include limiting the answers to a defined set of answers, eliminating answers, limiting the possible answers to a permitted dollar range, and limiting the potential answers to a permitted date range.

The employee benefit plan can be a defined benefit plan such as a pension plan, a defined contribution plan such as a 401(k) plan, a 403(b) plan, a stock purchase plan, or a 457 plan, or in some embodiments a health and welfare plan such as a medical insurance plan, a dental insurance plan, or a life insurance plan. The operational parameters may describe investment options available to participants in defined contribution plans and defined benefit plans, or healthcare options available to participants in a health and welfare plan. In some embodiments, the system can further include a component storage module for storing the developed application components.

In another aspect, the invention relates to a computerized system for implementing an employee benefit plan. The system includes an application server for constructing an input form from application components. The form includes one or more questions relating to operational parameters of the employee benefit plan, at least one of which allows for a response to include multiple answers, and one or more instructions for dynamically modifying the forms based on the response. The system also includes a web server in communication with the application server for transmitting the forms to and receiving the forms from a user of the system.

The application components can be input forms, menu items, implementation stages, templates, tables, questions, system locations, or answer sets. The system can also include a data transmission module in communication with the web server for providing responses received on the forms to one or more external systems. The responses can be provided using direct transmission over a communications network. The responses can also be provided using web services. The system can also include a component storage module for storing the application components.

The employee benefit plan can be defined a benefit plan such as a pension plan, a defined contribution plan such as a 401(k) plan, a 403(b) plan, a stock purchase plan, or a 457 plan, or in some embodiments a health and welfare plan such as a medical insurance plan, a dental insurance plan, or a life insurance plan. The operational parameters may describe investment options available to participants in defined contribution plans and defined benefit plans or the healthcare options available to participants in a health and welfare plan.

The instructions to modify the input form can be instructions to render another application component non-functional. The instructions to modify the form can define one or more permissible answers to the questions. Defining the permissible answers to the questions can include limiting the answers to a defined set of answers, eliminating answers, limiting the possible answers to a permitted dollar range, and limiting the potential answers to a permitted date range. In some embodiments, the system further includes a business rule parser for building the instructions (which may be written in javascript, for example) from a set of business rules, and may, in some embodiments, also include an auditing module for confirming that the received forms contain answers consistent with the set of business rules.

In another aspect, the invention relates to a computerized method for collecting the operational parameters of an employee benefit plan. The method includes dynamically constructing a data input form (in HTML, for example) from a set of application components. The data input form includes one or more questions relating to operational parameters of the employee benefit plan, at least one of which allows a response comprising multiple answers, and one or more instructions for dynamically modifying the input form based at least in part on a response comprising multiple answers. The method also includes transmitting the data input form to a user, and receiving a modified version of the input form from the user, the modifications being determined by the instructions and comprising the operational parameters of an employee benefit plan.

The application components can be one or more of a menu item, a question, an implementation stage, a system location, and an answer set. The instructions can be created from a set of business rules describing the relationships among the questions, and in some embodiments may be written in javascript. In some embodiments, the method also includes confirming that the received modified input form contains data consistent with the business rules. The employee benefit plan can be a defined benefit plan such as a pension plan, a defined contribution plan such as a 401(k) plan, a 403(b) plan, a stock purchase plan, or a 457 plan, or a health and welfare plan such as a medical insurance plan, a dental insurance plan, or a life insurance plan. The operational parameters may describe investment options available to participants in defined contribution plans and defined benefit plans or the healthcare options available to participants in a health and welfare plan.

The instructions to modify the input form can be instructions to render another application component non-functional. The instructions to modify the form can define one or more permissible answers to the questions. Defining the permissible answers to the questions can include limiting the answers to a defined set of answers, eliminating answers, limiting the possible answers to a permitted dollar range, and limiting the potential answers to a permitted date range.

Another aspect of the invention features a computerized method for providing the operational parameters of an employee benefit plan. The method includes receiving a first instance of an input form (in HTML format, for example) at a web browser. The input form includes one or more questions relating to the operational parameters of an employee benefit plan and one or more instructions for modifying the input form based on answers to the questions, where at least one of the questions allows a response comprising multiple answers. The method further includes providing multiple answers as a response to one of the questions, thereby causing the web browser to dynamically create a second instance of the input form based on the instructions, and submitting the second instance of the form to a server.

The instructions can be written in javascript, and in some embodiments derived from a set of business rules describing the relationships among the questions. The employee benefit plan can be a defined benefit plan such as a pension plan, a defined contribution plan such as a 401(k) plan, a 403(b) plan, a stock purchase plan, or a 457 plan, or a health and welfare plan such as a medical insurance plan, a dental insurance plan, or a life insurance plan. The operational parameters may describe investment options available to participants in defined contribution plans and defined benefit plans or healthcare options available to participants in a health and welfare plan.

The instructions to modify the input form can be instructions to render another application component non-functional. The instructions to modify the form can define one or more permissible answers to the questions. Defining the permissible answers to the questions can include limiting the answers to a defined set of answers, eliminating answers, limiting the possible answers to a permitted dollar range, and limiting the potential answers to a permitted date range.

Another aspect of the invention features an apparatus for collecting the operational parameters of an employee benefit plan. The apparatus comprises a memory for storing executable instructions and a processing system for executing the instructions. The instructions include transmitting a data input form to a user including one or more questions relating to operational parameters of an employee benefit plan, at least one of the questions allowing a response comprising multiple answers and one or more instructions for dynamically modifying the input form based on a response comprising multiple answers. The method also includes receiving responses to at least a subset of the questions.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is an illustration of an environment in which an embodiment of the invention can operate.

FIG. 2A illustrates one approach of implementing a system for capturing operational parameters of employee benefit plans.

FIG. 2B illustrates another approach of implementing a system for capturing operational parameters of employee benefit plans according to the invention.

FIG. 3 is a block diagram illustrating one embodiment of the invention.

FIG. 4 is a block diagram of one embodiment of a server in the system of FIG. 3.

FIG. 5 is a block diagram of one possible embodiment of a system according to the invention.

FIG. 6 is a screen display of an application maintenance screen in an embodiment of the invention.

FIG. 7 is a screen display of a menu edit screen in an embodiment of the invention.

FIG. 8 is a screen display of a table edit screen in an embodiment of the invention.

FIG. 9 is a screen display of a question definition screen in an embodiment of the invention.

FIG. 10 is a screen display of a table-based question entry screen in an embodiment of the invention.

FIG. 11 is a screen display of a table screen with a business rule in an embodiment of the invention.

### DESCRIPTION

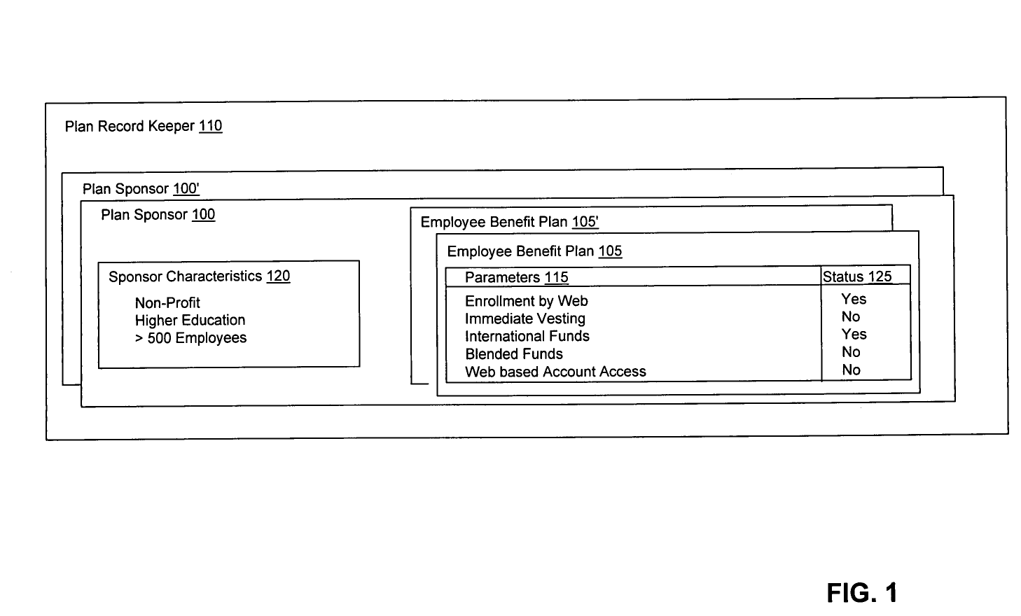

Referring to FIG. 1, in one embodiment, a plan sponsor (“sponsor”) 100 provides one or more employee benefit plans (“plans”) 105 and 105′ to its employees. Because of the significant overhead and regulatory requirements involved in the development and record-keeping for the plans 105, many plan sponsors 100, 100′ contract with a plan record-keeper 110 to provide these services. Examples of plan record-keepers include financial services companies such as banks, brokerage houses, insurance companies, and individual financial advisors, as well as data processing companies. In some cases, the record-keeper 110 may act as a plan administrator as defined under ERISA and have fiduciary responsibilities toward the plan sponsor 100, and in some cases may have no such relationship with the sponsor 100 and provide only data processing and record-keeping services. In some cases, the record-keeper 110 offers various types of plans 105 to sponsors 100. The number, types, and operational parameters 115 of a plan 105 may depend, for example, on certain characteristics 120 of the sponsor 100, the sponsor's financial commitment to the plan 105, as well as other factors.

For example, a record-keeper 110 may offer various plans 105 with numerous optional parameters 115 to a sponsor 100 such as large public corporation with thousands of employees who participate in the plan 105. The plans 105 may include a defined contribution plans such as a 401(k) or 403(b) plans, defined benefit plans such as a pension plans, and health and welfare plans such as medical and dental insurance plans, life insurance, and disability insurance. Parameters 115 may include services offered with the benefit plans 105, design features of the plans 105, or both. Further, parameters 115 may include web-based enrollment and customer service, a dedicated support staff, a large number of investment options, availability of loans, vesting periods, and others. In another example, the same record-keeper 110 may offer only one plan 105 (e.g., a 403(b) or similar plan) to a sponsor 100 such as a small non-profit organization. In cases where such small, non-profit sponsors 100 cannot afford multiple large plans 105 with a wide variety of optional parameters 115, the sponsors 100 often elect not to include these parameters 115 in the plan or plans 105 offered to their employees. Proper record-keeping of the plans 105 requires that the record-keeper 10 maintain the status 125 of each attribute 115 for each plan 105 offered by each sponsor 100. In addition, record-keeper 110 also may implement new parameters 115, or make changes to the status 125 of one or more parameters 115 at the request of the sponsor 100. To address these significant data processing requirements record-keepers 110 generally rely on large-scale computer systems to deploy and administer the benefit plans 105.

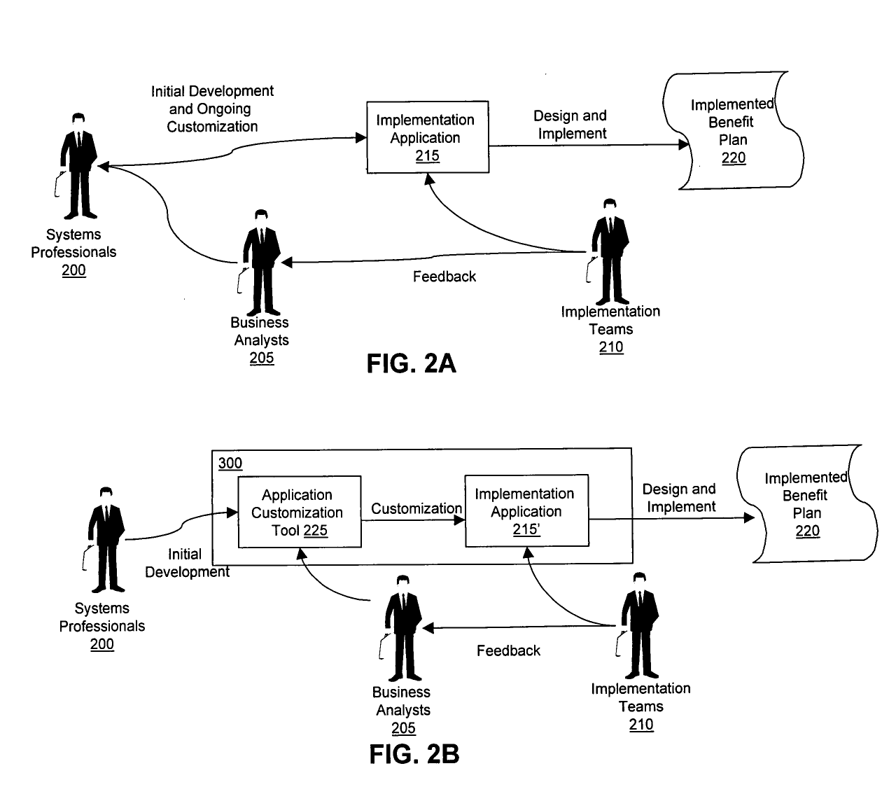

Referring to FIG. 2A, a typical approach to the design and use of such a system for implementing and administering employee benefit plans involves systems professionals 200, business analysts 205, and implementation teams 210. The systems professionals 200 develop and install an implementation application 215 with which the implementation teams 210 can define and implement benefit plans for sponsors, within the parameters of the implementation application 215. However, the business rules governing the parameters of the plans can change over time and new products are introduced that require the addition of new operational parameters. In such cases, the implementation teams 210 provide feedback to the business analysts 205, who document the necessary changes and assess their impacts on other systems. The business analysts 205 then confer with the systems professionals 200 and communicate the requested enhancements. The systems professionals 200 then modify the software code of the implementation application 215 according to the requests, and release an updated version of the application 215. This process becomes cumbersome and expensive because any changes to the implementation application 215 requires consultation with expensive and resource constrained systems professionals 200. Further, the time lag incumbent in the process is often not acceptable to the implementation teams 210 due to commitments to sponsors and management.

In contrast, the invention provides a system that allows for the easy and substantially instantaneous modification and customization of the implementation application 215. Referring to FIG. 2B, the same three roles (systems professionals 200, business analysts 205, and implementation teams 210) are present. But, in addition to developing the implementation application 215, the systems professionals develop and install an application customization tool 225. Together, the implementation application 215 and the application customization tool 225 make up an employee benefit plan implementation system 300 that eliminates the need for the systems professionals 200 to become involved whenever business rules change or new products are introduced that impact the functionality of the implementation application 215. The application customization tool 225 provides a environment in which the business analysts 205 can quickly implement changes to the implementation application 215 requested by the implementation teams 210. Using the application customization tool 225, business analysts 205 can control the default plan provisions that are used as the starting point for the implementation of a new plan, and the application components that make up the application 215. The application components can include: the available menu options within the implementation application 215, the questions asked of the implementation teams 210 during the implementation process, the valid answer set for the questions, the business rules describing the impact of answers upon other questions, as well as other functional aspects of the implementation application 215. The immediacy with which business analysts 205 can react to and implement these changes allows the implementation teams 210 to design and implement benefit plans 220 without the need to involve the systems professionals 200.

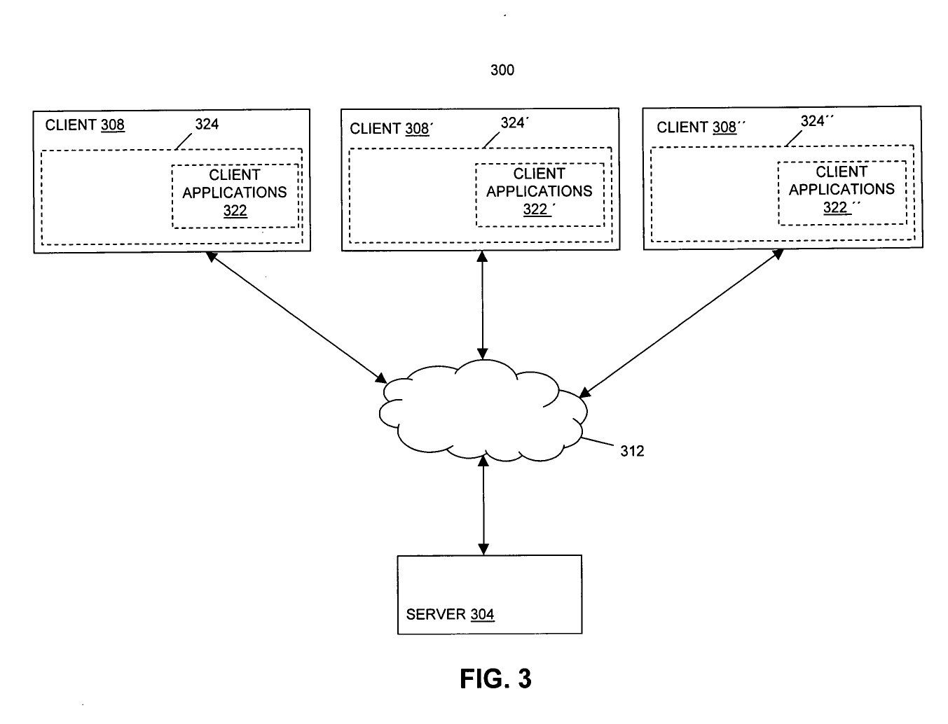

Referring to FIG. 3, in one embodiment, the methods described above may be implemented using an employee benefit plan implementation system 300 including at least one server 304, and at least one client 308, 308′, and 308″, generally 308. As shown, the system 300 includes three clients 308, 308′, 308″, but this is only for exemplary purposes, and it is intended that there can be any number of clients 308. The client 308 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 308 could also be implemented on such hardware as a smart or dumb terminal, network computer, personal data assistant, wireless device, information appliance, workstation, minicomputer, mainframe computer, kiosk, or other computing device, that is operated as a general purpose computer or a special purpose hardware device solely used for serving as a client 308 in the employee benefit plan implementation system 300.

Record-keepers 110 of one or more plans 105 may operate the clients 308 on behalf of their clients, the plan sponsors 100, or in some cases, the plan sponsor may provide staff members to the business analyst teams or implementation teams. In various embodiments, the client computer 308 includes client applications 322. One example of a client application 322 is a web browser application that allows the client 308 to request a web page (e.g., from the server 304) with an HTTP web page request. An example of a web page is a data file that includes computer executable or interpretable information, input forms, graphics, sound, text, and/or video, that can be displayed, executed, posted, played, processed, streamed, and/or stored and that can contain links, or pointers, to other web pages. In one embodiment, a user of the client 308 manually requests a web page from the server 304. Alternatively, the client 308 automatically makes requests with the web browser. Examples of commercially available web browser software are INTERNET EXPLORER, offered by Microsoft Corporation of Redmond, Wash., and NETSCAPE NAVIGATOR, offered by AOL/Time Warner of Mountain View, Calif.

A communications network 312 connects the client 308 with the server 304. The communication may take place via any media such as standard telephone lines, LAN or WAN links (e.g., T1, T3, 56 kb, X.25), broadband connections (ISDN, Frame Relay, ATM), wireless links, and so on. Preferably, the network 312 can carry TCP/IP protocol communications, and HTTP/HTTPS requests made by the web browser and the connection between the client applications 322 and the server 304 can be communicated over such TCP/IP networks. The type of network is not a limitation, however, and any suitable network may be used. Typical examples of networks that can serve as the communications network 312 include a wireless or wired ethernet-based intranet, a local or wide-area network (LAN or WAN), and/or the global communications network known as the Internet, which may accommodate many different communications media and protocols.

In some embodiments, an employee of the record-keeper 110 operates a central server 304, which interacts with clients 308. In some embodiments, a third party may manage the server 304, which may include providing the hardware, communications, and services to the server 304. The server 304 is preferably implemented on one or more server class computers that have sufficient memory, data storage, and processing power and that run a server class operating system (e.g. SUN Solaris, GNU/Linux, MICROSOFT WINDOWS 2000, or other such operating system). Other types of system hardware and software than that described here could also be used, depending on the capacity of the device and the number of users and the amount of data received. For example, the server 304 may be part of a server farm or server network, which is a logical group of one or more servers. As another example, there could be multiple servers 304 that may be associated or connected with each other, or multiple servers could operate independently, but with shared data. As is typical in large-scale systems, application software could be implemented in components, with different components running on different server computers, on the same server, or some combination.

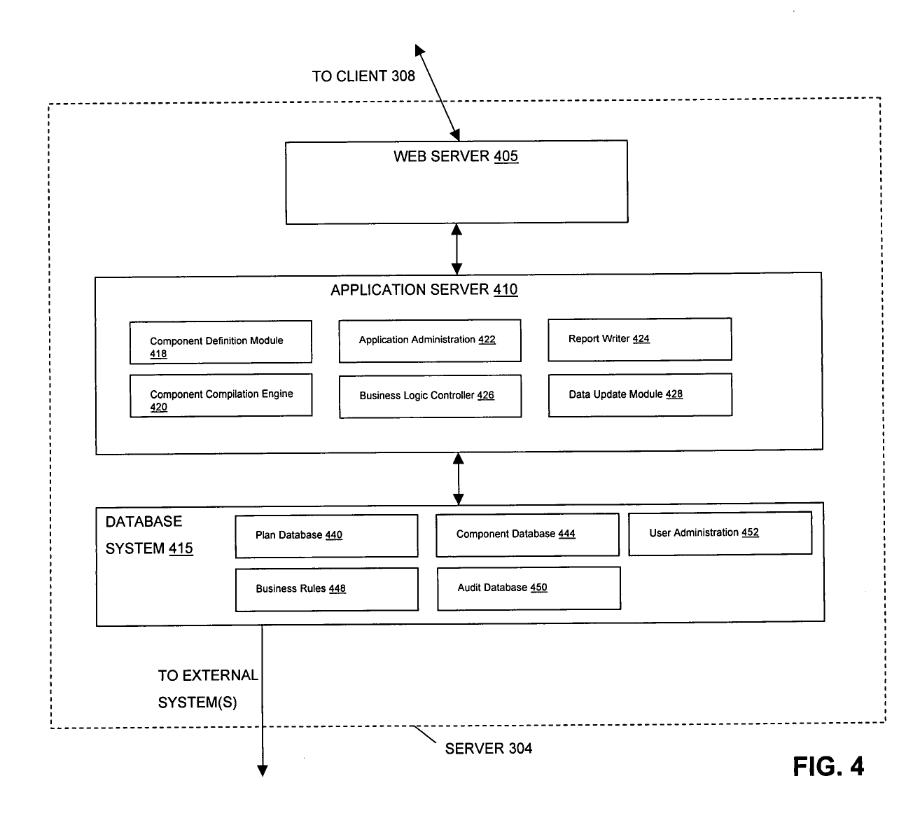

Referring to FIG. 4, in one embodiment, the server 304 includes a web server module 405 that serves as the communication interface with clients 308 involving the transfer of files and data. In some embodiments, the web server module 405 is the interface for communication with clients 308 involving HTTP/S requests and responses, Java messages, SMTP messages, POP3 messages, web services using, for example, SOAP/XML, instant messages, as well as other electronic messages. In some instances, messages may be transferred from the client 308 to the server 304, from the server 304 to the client 308, or both. The web server module 405 can be implemented as software running on one or more servers, or may be implemented as a stand-alone server. The web server module 405 can also provide the conduit through which the server 304 communicates with other applications, servers, web services, and devices for the purpose of data transmission, data sharing, and data replication.

The web server module 405 communicates with an application server 410, which provides the main programming logic for the operation of the system 300. In one embodiment, the application server 410 is implemented as one or more application programs (e.g., Internet Information Server from Microsoft Corporation, WebSphere from International Business Machines Corporation, or other such application) running on a server class computer, which may be the same or different computer as the web server module 405. The application server 410 receives requests for employee benefit plan data, constructs HTML forms for capturing information about employee benefit plans, transmits the forms to users, and receives data from the users via the web server 405 on forms completed on the client 308. The application server 410 may also receive requests for data stored in a database system 415 (such as participation rates, account balances, participant statistics, etc.) from users via a client 308 and the web server module 405.

The application server 410 includes: a component definition module 418, a form generation engine 420, an application administration engine module 422; a report writer 424; a business logic controller 426; and a data update module 428 for managing the interaction between the application server 410 and the database system 415.

The component definition module 418 facilitates the development of and changes to application components such as menus, tables, questions, valid answer sets, and system locations as well as business rules that govern the interaction among the components. For example, if a regulatory changes allowed plan participants to withdrawal funds without penalty beginning on their 55^{th} birthday, new questions would be necessary to provide the operational parameters for benefit plans that wish to take advantage of this opportunity. Instead of relying on systems professionals 200 to reprogram the implementation application 215, business analysts use the component definition module 418 to build the new question set, provide the permitted answers for each question, define any business rules associated with the questions, and assign the questions to one or more menus, screens, tables, or implementation stages. The new functionality is then immediately available to the implementation team members 210 through an updated implementation application 215.

The component compilation engine 420 reads static HTML stored in files on the application server 410, requests information describing the application components from the database system 415, and the javascript created by the business logic controller 426 to produce completed HTML pages, which are sent to the client 308 via the web server 405. The HTML pages include one or more menus, questions, and valid answer sets regarding a specific plan 105 being implemented, modified, or audited by the user. In some embodiments, the compilation of HTML code uses the Active Server Page (“ASP”) technology from Microsoft Corporation to combine static HTML and context specific data into one or more HTML pages prior to being sent to the client 208. In some embodiments, JAVA, JavaScript, XML, or other similar programming languages can be used to generate HTML code or present data, text and/or graphics to a user. In one exemplary embodiment, the HTML pages include forms, which are presented to a user on the client 308. The forms allow the user to input data, select from a series of options, and provide other responses to questions presented on the form. In one exemplary embodiment, the data refers to the operational parameters of an employee benefit plan and the status of one or more parameters of the plan. Upon completing a form, the user sends the completed form via an HTTP post command to the web server 405, which in turn provides data to the application server 410 and the database system 415. In some embodiments, the input forms are dynamically modified according to the executable software included with the form as the user provides responses to questions. Modifications include disabling certain menu options, disabling or enabling other questions, and modifying valid answer sets based on previously provided responses. Because the business rules governing the modifications are included with the forms prior to being sent to the client, they can be effectuated without requiring the user to post the form back to the server 410, thus saving time and processing resources.

The business logic controller 426 receives requests from the component compilation engine 420 to provide properly formatted computer code in the form of javascript. The javascript provides the instructions to the client-resident browser application 322 for dynamically modifying the HTML form based on the business rules governing the application components of the form, previously supplied answers stored in the database 415, and answers entered on the current form but not yet posted to the database 415.

For example, each question and the corresponding valid values for the questions are identified using a unique identifier, and the business rules are constructed using English-like text by non-programmers and stored in the database 415. For example, a question may be irrelevant if a previous question is answered “Yes” and any one of multiple answers supplied in response to another previous question contains the text “Big Equity Fund” or if a third question is answered “No.” To implement this business rule into the implementation application, a business analyst formulates a business rule using the application customization tool. One possible example of the expression of the business rule is provided below:
Q11=”off” if ((Q1=“Yes”) and (Q2[ANY]=”Big Equity Fund”)) or Q3=“No”).

Once the business rules are stored in the database 415, the business logic controller 426 parses the business rule(s) into its basic components such as question numbers, logical operators, and values and provides a javascript representation of the rule to the component compilation engine 420, which in turn compiles any additional application components into an HTML form and provides the form to the client 308 via the web server 405. One possible example of javascript that may be used to express the business rule described above is shown below:

var allBlank = false;

if ( (document.sq.q2_1.value == ″) &&
(document.sq.q2_2.value == ″) &&
(document.sq.q2_3.value == ″) ) {

allBlank = true; }

if (allBlank==true) {

alert(‘Question 2 drives the value of this question -
please complete it

first’);

document.sq.q2_1.focus( );

}
if (q3_1.value==″) {

alert(‘Question 3 drives the value of this question -
please complete it

first’);

q3_1.focus( );

}
if (((‘yes’==‘yes’) && ( ( (
document.sq.q2_1.value.toLowerCase( ) ==‘big equity
fund’) ) ∥ ( ( document.sq.q2_2.value.toLowerCase( ) ==
‘big equity fund’) ) ∥ ( (
document.sq.q2_3.value.toLowerCase( ) ==‘big
equity fund’) ) )) ∥ (
(document.sq.q3_1.value.toLowerCase( ) ==‘no’) ) ) {

setVoid(this); goToNext(this); }

else if (this. value == ‘xxVOIDxx’) {

setClear(this); goToNext(this); }

In the above example, the questions driving the relevance of the question include questions that are on the same page as the target question (e.g., questions 2 and 3 are on the same HTML form as question 11), as well as a question that was answered on a previous HTML form (e.g., question 1 is on another HTML document). In other cases, all of the questions driving the target question may be on the same HTML form as the target question, or all of the questions driving the target question may be on different HTML forms as the target question. By allowing business rules to operate against any question whether on screen or off, the system 300 provides greater flexibility to the business analysts responsible for modifying the implementation application.

The application server 410 also includes a report writer 424 that compiles data, text, graphics and other information from the database system 415 or other applications and other components of the application server 410 and produces reports for users of the system 300. For example, the report writer 424 compiles information from the database system 415 regarding the parameters for each of the plans currently offered by a particular sponsor into a client confirmation report. The implementation team can then use the client confirmation report as a quality control mechanism to review the captured data and selected parameters to ensure the plans are set up according to plan guidelines. In one embodiment, the report can generated in HTML, sent from the server 304 to the client 308 over the communications network 312, and viewed on a client application 322, printed, or saved locally to the client 308.

The database system 415 stores data related to the employee benefit plans 105, the plan sponsors 100, user permissions, application component definitions, and business rules in one or more databases. The database server 415 also provides data to the application server 410 upon request, and updates data as necessary. The database system 415 includes a plan database 440 containing information about specific plans as implemented for particular sponsors and template plans used as initial models for new plan implementations; a component database 444 containing data describing the application components such as questions, valid answer sets, application menus, system locations, and table definitions; a business rules database 448 for storing the business rules as defined by the users describing the relationships among the application components; an audit database 450 for capturing the audit history of changes made to the application components; and a user administration database 452 containing user identification, password, security, and authorization data describing the users' access rights and privileges. Examples of the database system 415 include the MySQL Database Server by MySQL AB of Uppsala, Sweden, the SQLServer database system of Microsoft Corporation of Redmond Wash., and the ORACLE Database Server offered by ORACLE Corp. of Redwood Shores, Calif.

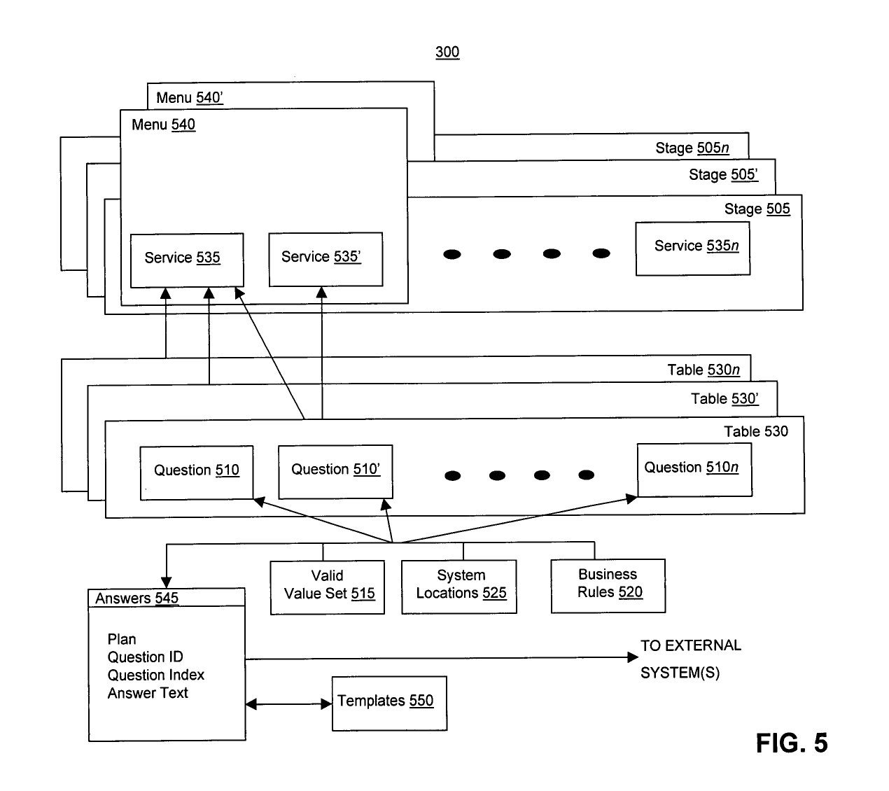

Referring to FIG. 5, the system 300 provides the various application components used to implement, audit, or modify the parameters that define the operational aspects of employee benefit plans 105. The implementation phase of a benefit plan can be decomposed into numerous high-level stages 505, 505′, 505″, generally 505 representing the phases of data capture and plan setup during the implementation process. As shown, the system 300 includes three stages 505, 505′, 505″, but this is only for exemplary purposes, and it is intended that there can be any number of stages 505. For example, the stages of the implementation process can include capturing sponsor information, defining investment options, loan processing, vesting schedules, and capturing employee information. At its most granular level, the implementation process is executed through the completion of detailed, often interrelated questions 510, 510′, 510″, generally 510. Each question 510 references a valid value set 515. The value set 515 contains pre-screened, validated answer sets that pre-populate the forms, dialog boxes, drop-down boxes, and text forms from which the users select the appropriate answer(s) for a given plan.

For example, during the implementation of a plan a member of the implementation team is asked to select from one of three possible vesting schemes for a defined contribution plan such as a 401(k) plan. In many cases, plan sponsors use vesting to encourage employee loyalty and retention by supplementing an employee's contributions with additional company funds that are credited to the employee's account but are not “owned” by the employee until the employee has reached a certain employment milestone. One such approach is to deposit funds each month as a percentage of an employee's salary (e.g., 1%), and the finds are accrued in the employee's account. However, the “vested” amount is determined by the duration of the employee's tenure with the sponsor according to a schedule similar to the schedule described below:

TABLE 1
Vesting Schedule

| | |
|---|---|
| Employment Duration | Vesting Percentage |

| | | |
|---|---|---|
| <3 | Years | 0% |
| 3-4 | Years | 25% |
| 4-5 | Years | 50% |
| >5 | years | 100% |

The actual percentages and vesting periods may vary significantly, however to simplify the implementation and administration of the plans, many record-keeping firms limit the options to a fixed set of vesting schedules. Therefore, when setting up the plan, the system presents the user with a question 510 requesting the identification of a preferred vesting plan and a set of valid responses 515 that represent the potential combinations of percentages and service durations necessary for vesting. In conjunction with requesting the vesting schedule, the system also requests the sponsor's contribution percentage—often referred to as the “match.”

In some embodiments, the selection of a high sponsor match (e.g., over 4%) may preclude the selection of one or more vesting schedules. To facilitate such intra-question dependencies, the system 300 also provides a set of business rules 520. The business rules 520 provide the processing rules governing intra-question dependencies and the overall business constraints. The business rules 520 allow the system 300 to alter its functionality in real-time as the user provides information regarding a particular plan to avoid unnecessary repetition and the presentation of irrelevant questions.

In some embodiments, the business rules 520 may describe dependencies among questions 510 answered during previous stages 505 such that the data used to drive the business rule resides in the database 415. For example, one question 510 that is typically answered early in the implementation process is the non-profit status of the sponsor. Because the identification of a sponsor as a non-profit entity has numerous downstream effects due to statutory limitations, IRS rules, and the like, many questions 510 that are relevant to plans being implemented for a for-profit sponsor become irrelevant. Similarly, some questions such as the vesting questions discussed above are closely related to each other and may appear on the same screen during the implementation process. In such cases, the business rules 520 are used to alter the question list and valid value set 515 of a current input form without having to refer to the database 415. Bypassing the requirement of posting answers to the database 415 and subsequently retrieving the data saves processing time because it eliminates an HTTP post and HTTP get command between the client 308 and the server 304 and significantly improves the response times experienced by the user.

In one version of the invention, the business rules 520 implement constraints on questions 510 and valid value sets 515 based on multiple answers to a single question 510, as well as multiple answers to multiple questions 510. For example, a first question requesting the types of withdrawal transactions that are permitted may allow for multiple answers as a response, such as payout at death, payout upon separation, and payout at age 59½. If each type of permitted withdrawal can only be initiated by written, signed request from the plan participant, a subsequent question 510 regarding the online withdrawal request options is no longer relevant, and therefore disabled. If, however, the list of possible withdrawal transactions included a withdrawal that did not require a signed document such as full payout on request, the online payout request questions would be enabled. Thus, the individual answers that make up a complete response to a question allowing multiple answers can impact other questions either independently, or in combination with other answers to that same question, or other previously answered questions.

In some embodiments, the data provided in response to questions is forwarded to other external systems. In such cases, a system location 525 component is used to define the system and location to which the data will be sent and the method of transfer (e.g., FTP, synchronous transmission, flat file feed, XML/SOAP). For example, as a plan is implemented, data regarding the plan's sponsor is captured for reporting and recordkeeping purposes. This information may also be utilized in marketing campaigns, or as default information for other plans. In such a case, a system location component is created to manage the transmission of data describing the sponsor such as the company name, address, contact information, legal status, etc. to external systems.

Multiple questions 510 can be grouped into one or more tables 530. By assigning multiple questions 510 to a table 530, multiple answers to a question 510 can be captured as a single, valid response. Furthermore, by uniquely identifying tables 530 and questions 510 with unique identification numbers, business analysts can formulate business rules 520 referencing the tables 530 and the questions 510 within the tables 530. Thus, the answers provided in the tables drive the business rules and can be used to dynamically manipulate the forms. For example, a question such as “How many mutual funds will be available as investment vehicles?” might require a user to provide a numerical answer. If the user enters a number greater than one, the subsequent question requesting the names of the mutual funds available in that plan would include an answer table with the number of rows equal to the answer to the numerical answer provided for the previous question. In addition, as the user selects a fund name from a drop down selection field populated with valid answers (i.e., mutual fund names) for one row of the table, the list of available funds for the next row of the table will no longer include previously selected fund names. Because the system processes the business rules 520 governing the activated questions 510 and valid answers without posting previous responses to the database 415, the response times experienced by the users and the opportunities for data entry errors are greatly reduced.

Questions 510 can also be logically grouped into services 535. Services represent a feature of a benefit plan, such as loans, stock purchases and participant web access, which may be offered by the plan record-keeper as additional, optional aspects of a benefit plan. For example, a question 510 regarding the availability of loans from a particular plan may have valid responses of “yes” and “no.” If the user of the system 300 provides a response of “no” to such a question, the loan service 535 is not active, and the series of questions needed to implement the loan service is not be presented to the user. If, on the other hand, the user provides a response of “yes,” the loan service is turned on, and the subsequent questions 510 requesting more detailed information about the loan processing (e.g., amounts, payback terms) are presented to the user for completion. This allows for the availability of entire groups of questions to be manipulated by assigning them to a service 535 and activating or deactivating the service 535.

In some embodiments, services 535 are logically grouped into application components referred to as menus 540. Menus 540 facilitate the navigation of the system though question sets, services 535, and stages 505 as well as allowing the user to manipulate the application components themselves. Depending on the specific service 535 being implemented or modified and the stage 505 of the implementation process, menus 540 may be activated or deactivated, and may have one or more menu options available to the user. The attributes of the menu application components, i.e., the stage 505 to which it is assigned, the ordering across the screen, and the functions available on the menu are stored in the component database 444 of the database system 415.

For each plan implemented using the implementation application, the answer sets 545 are captured in the plan database 440. The answer sets 545 represent the specific options selected for each question 510 answered throughout the implementation process, and together define the operational parameters of the employee benefit plan for which they were entered. In some embodiments, a set of predetermined answer templates 550 is provided for each type of benefit plan within the system 300. The templates 550 contain common answers to a core set of questions so that during the implementation process the number of data fields requiring data entry by users of the system 300 is minimized because each answer has already been validated based on the business rules 520.

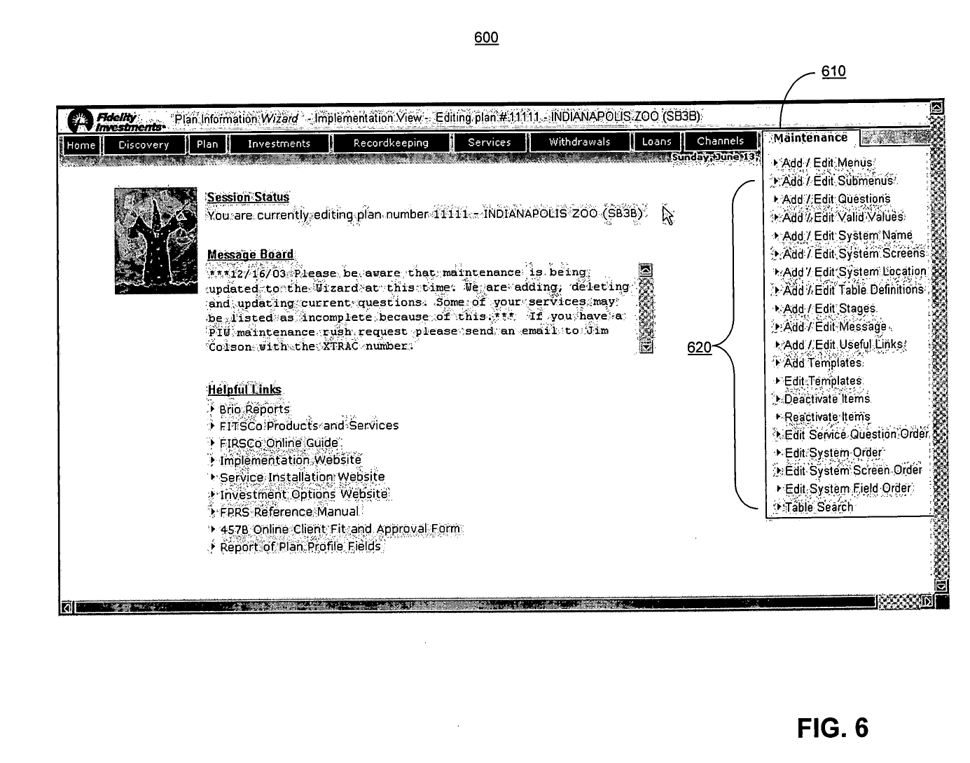

FIGS. 6 through 11 illustrate one embodiment of a system for implementing the methods and systems described above. Referring to FIG. 6, in one embodiment, the application server 410 provides an application maintenance screen 600 to the client 308 via the communications network 312. The application maintenance screen 600 provides the menu options with which a user of the system 300 can modify the various application components of the system 300. Included on the screen 600 is a maintenance menu 610, which further includes a listing of functions 620. For example, if new legal regulations require that each benefit plan be amended with information not currently captured by the implementation application, the Add/Edit Questions menu selection allows a user to create a new question to capture the new information. Likewise, the Add/Edit Menus and Add/Edit Stages menu option allow the user to specify the location within the implementation application and stage within the implementation process the question is to appear. The Add/Edit Valid Values menu option facilitates the entry of the permissible set of answers that will be available during the implementation process, and if necessary, the Add/Edit Table Definitions menu option allows the user to define complex question sets with multiple responses for each question.

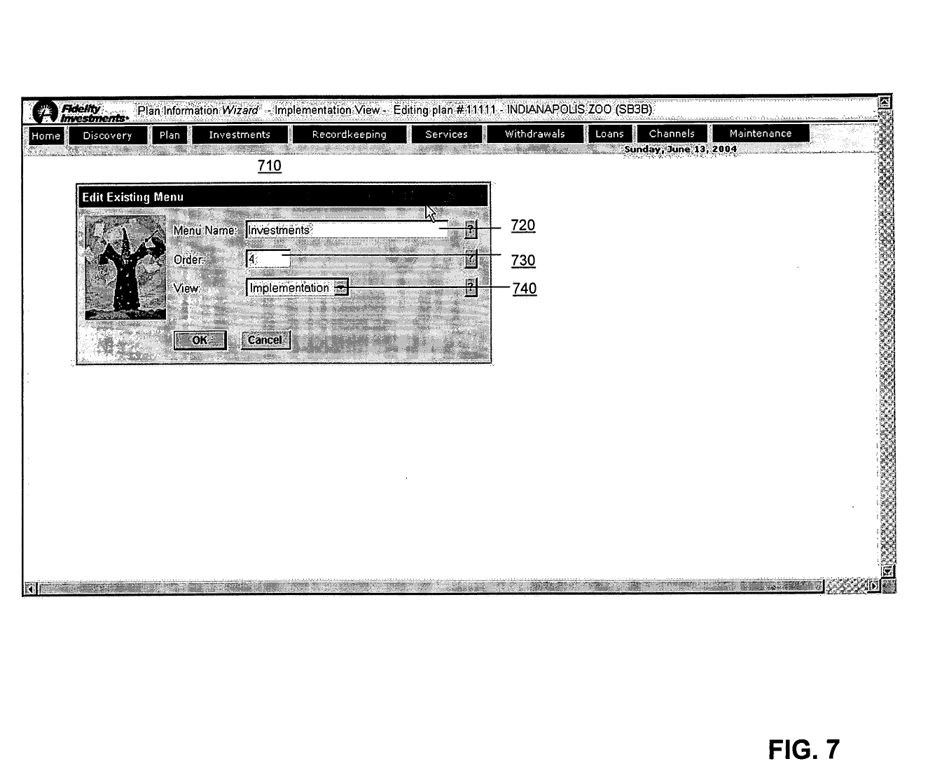

FIG. 7 illustrates one embodiment of an Add/Edit Menus screen 710 for modifying the menu structure of the implementation application. The screen 710 consists of a Menu Name field 720, an Order field 730, and a View field 740. The Menu Name field 720 includes a text box into which the user enters the name of a high-level menu option to be added to the implementation application. The Order field 730 includes a text box into which the user provides an integer representing the order the new menu option will appear in the menu structure of the implementation application. The View field 740 determines which bar menus will be seen in the implementation tool, in this case implementation or reconfiguration. For example, to add a menu item called “Investments” to the implementation application such that it is the fourth menu option across the top of the screen and is seen during the implementation process, a user enters “Investments” into the Menu Name field 720, “4” into the Order field 730, and selects “Implementation” from the View field selection box 740. The attributes of the menu application components are stored in the component database, and used to dynamically generate the menus from the tables in the database. In some embodiments, multiple table are used to store menu attributes, such as a main_menu table for storing data describing the main menu bar, and a submenu table for storing the data describing the submenu options available within each main menu. The application server retrieves the data from the component database and uses a java servlet to build the visual menus for presentation to the user. By storing the menu components and their attributes in a database they can easily be modified using an intuitive, menu driven application customization tool, and little (and in many cases no) programming knowledge is needed to affect functional changes to the implementation application.

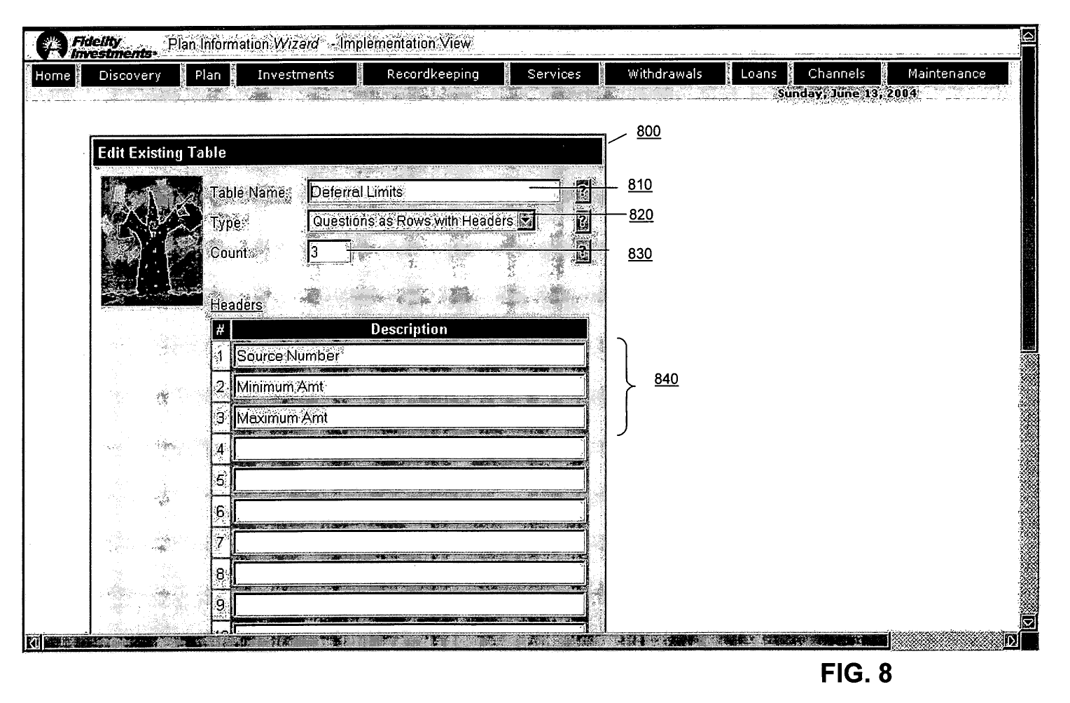

FIG. 8 illustrates one embodiment of an Edit Table screen 800 that facilitates modifications to the tables within the implementation application. As an example, the Edit Table screen 800 used to define the attributes of a table with multiple related questions includes a table name data entry field 810 for providing a descriptive name for the table; a table type data entry field 820 for selecting a table type; a count data entry field 930 for defining the number of responses that will be required for each question listed within the table; and a multiple field listing of column headers 840 for entering the text for the table column headers. For example, one possible operational parameter of a benefit plan is the amount of money that a participant in a plan can defer withdrawals from a particular source. To properly capture this information, the application must be able to accept a minimum and maximum deferment amount for each source from which a participant might receive compensation. Therefore, the user creates a Deferral Limits table comprising rows of questions requiring three elements of information for each row. The source number identifies which source of funds that particular row of the table relates to, and a minimum and maximum amount column allows for the entry of a numerical value representing the lower and upper deferral limits. By providing the Edit Table screen 800, business analysts and other non-programmer staff members can implement and modify the functionality of the implementation application to match changes in laws governing the plans, new or changed policies relating to the operations of the record-keeping companies, or options selected by the sponsors on an as needed, real time basis without involving the systems professionals.

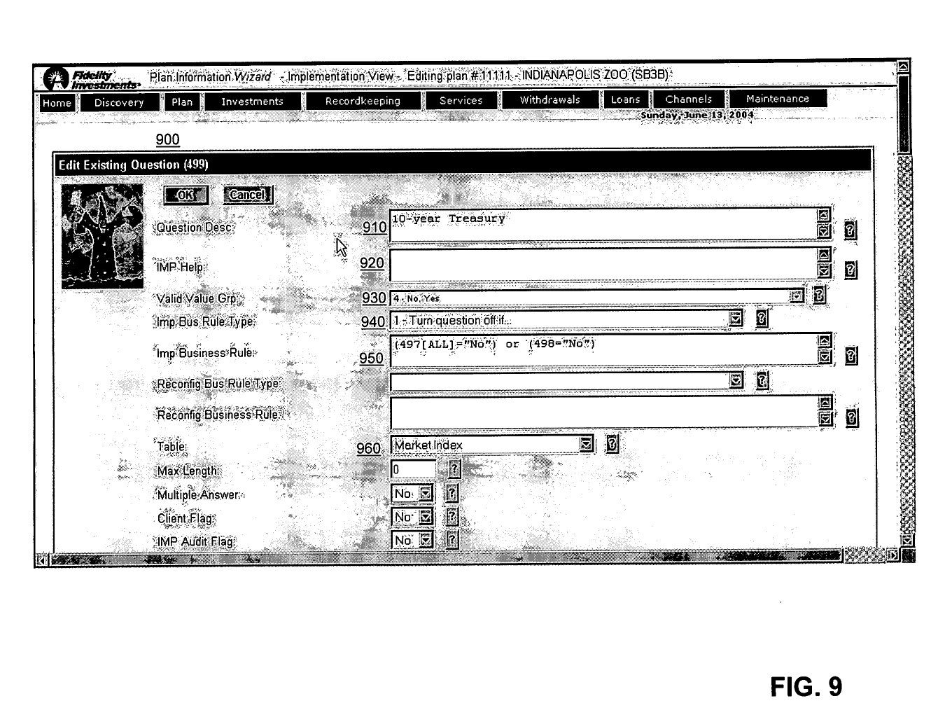

FIG. 9 illustrates one embodiment of the Edit Question screen 900 used to define and implement new questions. For example, one embodiment of the implementation process may include deciding whether the 10-year treasury market index will be presented to plan participants, and if so, through which communication channel(s). The Edit Question screen 900 includes, among other elements, data fields for capturing a question description 910, help text 920, a valid value group 930, a business rule type 940, business rule text 950, a table name 960, and a multiple answer flag 970. The question description field 910 allows a user to enter a descriptive, free-form text description of the question. The user may also use the free-form help text field 920 to enter clarifications, definitions, instructions, and other information that may be useful to an implementation team in answering the question. The valid value group field 930 provides a fixed listing of the valid values that are permitted responses to the question. In one embodiment, the list of selections for the valid value group field 903 is customizable by the user of the application customization tool. Examples of valid value groups include: [YES/NO], [1, 2, 3, 4, 5 ], [0, 25, 50, 100], [January, February . . . December], as well as other lists and ranges of potential answers that the users may need to complete a question. Also included on the Edit Question screen 900 is a business rule type field 940. The business rule type defines the functional operation of the business rule for that question. Valid business rule types include the following:

TABLE 2
Valid Rule Types

| Rule Type | Description |
|---|---|
| Off If | Question is deactivated and thus |
| | unanswerable if the conditions |
| | following the “If” statement are true |
| Match | For question to be operational, |
| | the answer for the question will be |
| | set to a previously provided answer |
| | to another question |
| Combo | Combination of Off If and Match - |
| | If question is not turned off due |
| | to the Off If rule, then the answer |
| | to that question must match a |
| | previously provided answer |
| Value | If a previous question has a |
| | certain value, then the current |
| | question must have a certain value |
| | (not necessarily the same value) |

In the example shown in FIG. 9, the 10-year treasury market index question will be turned off (i.e., implementation staff members will not be able to activate it for plan participants in this particular plan) if all the responses to question 497 are “no” and if one of the answers to question 498 is also set to “no.” Other rules describing the relationships among questions, answers to questions, and predetermined valid value sets also may be incorporated using combinations of the above rules, as well as other Boolean and logical operators.

The business rule field 950 is a text field into which the user of the application customization tool 225 enters the business rule with reference to other questions and tables using English-like logical statements. The business logic controller 426 parses the business rules, and in one embodiment, the controller 426 creates corresponding javascript for the rules and adds the javascript to the HTML files as the files are compiled by the component compilation engine 420. Questions may also be assigned to tables, and the table field 960 provides a drop-down listing of the available table names to which the question can be associated. In the above example illustrated in FIG. 9, the question regarding the availability of the 10-year treasury index is associated with the Market Index table. Other fields on the Edit Question screen 900 provide additional functionality for the user to specify the desired attributes of the question and how it interacts with other application components of the system.

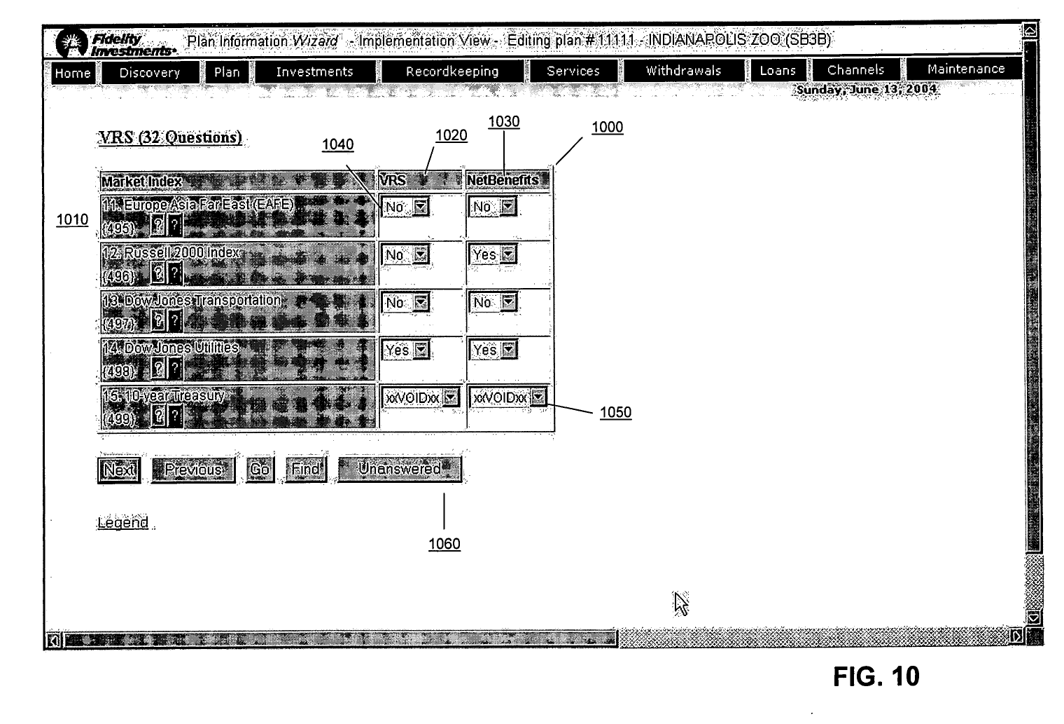

FIG. 10 illustrates one example of a screen 1000 within the implementation application containing a table-based series of questions. The list of questions 1010 is presented as the left-most column of the table, with two additional columns 1020 and 1030 representing two possible marketing channels through which a plan participant may request information about their benefit plan. For example, the questions 1010 refer to five different market indices that might be available for presentation to a plan participant through the telephone (Voice Response Unit, or “VRU”) and the web (“NetBenefits”). For each intersection of index and communication channel, the application provides a Yes/No drop-down field 1040 into which a member of the implementation team can specify whether or not the index will be presented to the user through that channel. Furthermore, business rules may control the interaction among the drop-down lists such that the selection or de-selection of one or more index/channel combination may render other lists “VOID” 1050. This is done using page-level events such as focusing the mouse on a particular application object (a menu, a question, an answer, etc.) or selecting an answer. By including the javascript versions of the business rules within the HTML sent to the client, and storing other relevant data at the client, interactions with the server are minimized, thus increasing implementation cycle times.

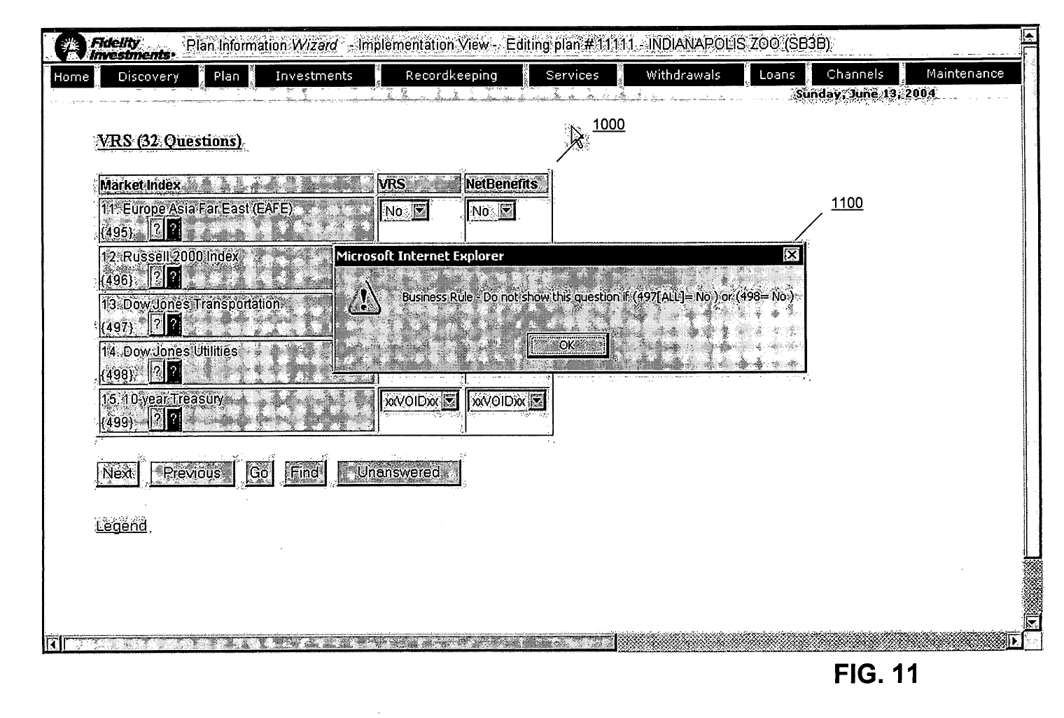

FIG. 11 illustrates an exemplary message 1100 presented to the implementation analyst describing the business rule that drives the availability of a particular question. The message 1100 provides insight into why a particular question is not available, i.e., what conditions must be met for it to be an operational question. This provides the implementation team with detailed insight into how the business rules are set up, and assists them with the identification of erroneous rules. For example, if an implementation team is setting up a benefits plan and the operational parameters they wish to modify are not available, the implementation team can quickly identify why those options are not available and the business rules that limit its availability. They can initiate a discussion with a business analyst or senior implementation team member as to why the rule is in place, or how better to draft the rule such that it allows the implementation to go forward as specified. No detailed knowledge of the programming logic is necessary to investigate the unavailability of an option, nor to change the business rule if in fact that is the solution deemed most appropriate.

Variations, modifications, and other implementations of what is described herein will occur to those of ordinary skill in the art without departing from the spirit and the scope of the invention. The invention is not to be defined by the preceding illustrative description.

What is claimed is:

1. A computerized system for dynamically generating an on-line questionnaire for collecting operational parameters of an employee benefit plan, the system comprising:
a component development module for developing application components, the application components comprising multiple attributes, a subset of which collectively effect the functionality of other application components;
a business rule parser for translating business rules into executable software code describing the collective effects of the application components on each other;
an application definition module for creating an on-line questionnaire definition relating to the operational parameters of the employee benefit plan using the application components; and
a compiler for dynamically generating the questionnaire based on the questionnaire definition and the executable software code.

2. The system of claim 1 wherein the application components are one or more of an input form, a menu item, an implementation stage, a template, a table, a question, a system location, and an answer set.

3. The system of claim 2 wherein a first application component can be comprised of one or more other application components.

4. The system of claim 2 wherein the application component is a system location and the system location comprises instructions for performing a data processing task.

5. The system of claim 1 wherein the multiple attributes are multiple answers to a single question.

6. The system of claim 5 wherein the collective effects of the multiple answers is to render other application components non-functional.

7. The system of claim 5 wherein the other application components are questions, and the collective effect of the multiple answers comprises defining one or more permissible answers to the questions.

8. The system of claim 7 wherein the defining one or more permissible answers to the questions comprises one or more of: limiting the permitted answers to a defined set, eliminating answers, limiting the possible answers to a permitted dollar amount range, and limiting the possible answers to a permitted date range.

9. The system of claim 1 wherein the employee benefit plan is one of a defined contribution plan, a defined benefit plan, and a health and welfare plan.

10. The system of claim 9 wherein the employee benefit plan is a defined contribution plan and the defined contribution plan is one of a 401(k) plan, a 403(b) plan, an employee stock option plan, and a 457 plan.

11. The system of claim 9 wherein the employee benefit plan is a defined benefit plan, and the defined contribution plan is a pension plan.

12. The system of claim 9 wherein the employee benefit plan is a defined contribution plan and the operational parameters describe investment options available to participants in the defined contribution plan.

13. The system of claim 9 wherein the employee benefit plan is a defined benefit plan and the operational parameters describe investment options available to participants in the defined benefit plan.

14. The system of claim 9 wherein the employee benefit plan is health and welfare plan and the health and welfare plan is one of a medical insurance plan, a dental insurance plan, and a life insurance plan.

15. The system of claim 9 wherein the employee benefit plan is a health and welfare plan and the operational parameters describe healthcare options available to participants in the health and welfare plan.

16. The system of claim 1 further comprising a component storage module for storing the developed application components.

17. The system of claim 1 wherein the executable software code is written in javascript.

18. A computerized system for implementing an employee benefit plan, the system comprising:
an application server for constructing an input form from application components comprising:
one or more questions relating to operational parameters of the employee benefit plan, at least one of the questions allowing for a response comprising multiple answers, and
one or more instructions for dynamically modifying the forms based on the response; and
a web server in communication with the application server for transmitting the forms to and receiving the forms from a user of the system.

19. The system of claim 18 wherein the application components are one or more of a menu item, a question, a system location, an implementation stage, a template, a table, a business rule, and an answer set.

20. The system of claim 18 further comprising a data transmission module in communication with the web server for providing responses received on the forms to one or more external systems.

21. The system of claim 20 wherein the responses are provided using direct transmission over a communications network.

22. The system of claim 20 wherein the responses are provided using web services.

23. The system of claim 18 wherein the employee benefit plan is one of a defined contribution plan, a defined benefit plan, and a health and welfare plan.

24. The system of claim 23 wherein the employee benefit plan is a defined contribution plan and the defined contribution plan is one of a 401(k) plan, a 403(b) plan, an employee stock option plan, and a 457 plan.

25. The system of claim 23 wherein the employee benefit plan is a defined benefit plan and the defined benefit plan is a pension plan.

26. The system of claim 23 wherein the employee benefit plan is a defined contribution plan and the operational parameters describe investment options available to participants in the defined contribution plan.

27. The system of claim 23 wherein the employee benefit plan is a defined benefit plan and the operational parameters describe investment options available to participants in the defined benefit plan.

28. The system of claim 23 wherein the employee benefit plan is health and welfare plan and the health and welfare plan is one of a medical insurance plan, a dental insurance plan, and a life insurance plan.

29. The system of claim 23 wherein the employee benefit plan is a health and welfare plan and the operational parameters describe healthcare options available to participants in the health and welfare plan.

30. The system of claim 18 wherein the instructions to modify the input form comprise rendering one or more questions on the form non-functional.

31. The system of claim 18 wherein the instructions to modify the input form comprises defining one or more permissible answers to the questions.

32. The system of claim 31 wherein defining one or more permissible answers to the questions comprises one or more of: limiting the permitted answers to a defined set, eliminating answers, limiting the possible answers to a permitted dollar amount range, and limiting the possible answers to a permitted date range.

33. The system of claim 18 further comprising a component storage module for storing the application components, the questions, and the instructions.

34. The system of claim 18 further comprising a business rule parser for building the instructions from a set of business rules.

35. The system of claim 34 further providing an auditing module for confirming that the received forms contain answers consistent with the set of business rules.

36. The system of claim 18 wherein the instructions are written in javascript.

37. A computerized method for collecting the operational parameters of an employee benefit plan, the method comprising:
dynamically constructing a data input form from a set of application components, the form comprising:
one or more questions relating to operational parameters of the employee benefit plan, at least one of the questions allowing a response comprising multiple answers; and
one or more instructions for dynamically modifying the input form based at least in part on a response comprising multiple answers;
transmitting the data input form to a user; and
receiving a modified version of the input form from the user, the modifications being determined by the instructions and comprising the operational parameters of an employee benefit plan.

38. The method of claim 37 wherein the application components are one or more of a menu item, a question, a system location, a template, a table, a business rule, and an answer set.

39. The method of claim 37 wherein the input form is generated using HTML.

40. The method of claim 37 wherein the instructions are created from a set of business rules describing the relationships among the questions.

41. The method of claim 40 further comprising confirming that the received modified input form contains data consistent with the business rules.

42. The method of claim 40 wherein the instructions are written in javascript.

43. The method of claim 37 wherein the employee benefit plan is one of a defined contribution plan, a defined benefit plan, and a health and welfare plan.

44. The method of claim 43 wherein the employee benefit plan is a defined contribution plan and the defined contribution plan is one of a 401(k) plan, a 403(b) plan, an employee stock option plan, and a 457 plan.

45. The method of claim 43 wherein the employee benefit plan is a defined benefit plan, and the defined benefit plan is a pension plan.

46. The method of claim 43 wherein the employee benefit plan is a defined contribution plan and the operational parameters describe investment options available to participants in the defined contribution plan.

47. The method of claim 43 wherein the employee benefit plan is a defined benefit plan and the operational parameters describe investment options available to participants in the defined benefit plan.

48. The system of claim 43 wherein the employee benefit plan is health and welfare plan and the health and welfare plan is one of a medical insurance plan, a dental insurance plan, and a life insurance plan.

49. The system of claim 43 wherein the employee benefit plan is a health and welfare plan and the operational parameters describe healthcare options available to participants in the health and welfare plan.

50. The method of claim 37 wherein the instructions to modify the input form comprise rendering one or more questions on the form non-functional.

51. The method of claim 37 wherein the instructions to modify the input form comprises defining one or more permissible answers to the questions.

52. The method of claim 51 wherein defining one or more permissible answers to the questions comprises one or more of: limiting the permitted answers to a defined set, eliminating answers, limiting the possible answers to a permitted dollar amount range, and limiting the possible answers to a permitted date range.

53. A computerized method for providing the operational parameters of an employee benefit plan, the method comprising:
receiving a first instance of an input form at a web browser, the input form comprising:
one or more questions relating to operational parameters of the employee benefit plan at least one of the questions allowing a response comprising multiple answers; and
one or more instructions for modifying the input form based on multiple answers to one of the questions;
providing multiple answers that define the operational parameters of an employee benefit plan as a response to one of the questions, thereby causing the web browser to dynamically create a second instance of the input form based on the instructions; and
submitting the second instance of the form to a server.

54. The method of claim 53 wherein the instructions are written in javascript.

55. The method of claim 54 wherein the javascript is derived from a set of business rules describing the relationships among the questions.

56. The method of claim 53 wherein the employee benefit plan is one of a defined contribution plan, a defined benefit plan, and a health and welfare plan.

57. The method of claim 56 wherein the employee benefit plan is a defined contribution plan and the defined contribution plan is one of a 401(k) plan, a 403(b) plan, an employee stock option plan, and a 457 plan.

58. The method of claim 56 wherein the employee benefit plan is a defined benefit plan, and the defined benefit plan is a pension plan.

59. The method of claim 56 wherein the employee benefit plan is a defined contribution plan and the operational parameters describe investment options available to participants in the defined contribution plan.

60. The method of claim 56 wherein the employee benefit plan is a defined benefit plan and the operational parameters describe investment options available to participants in the defined benefit plan.

61. The method of claim 56 wherein the employee benefit plan is health and welfare plan and the health and welfare plan is one of a medical insurance plan, a dental insurance plan, and a life insurance plan.

62. The method of claim 56 wherein the employee benefit plan is a health and welfare plan and the operational parameters describe healthcare options available to participants in the health and welfare plan.

63. The method of claim 53 wherein the instructions to modify the input form comprise rendering one or more questions on the form non-functional.

64. The method of claim 53 wherein the instructions to modify the input form comprise defining one or more permissible answers to the questions.

65. The method of claim 64 wherein defining one or more permissible answers to the questions comprises one or more of: limiting the permitted answers to a defined set, eliminating answers, limiting the possible answers to a permitted dollar amount range, and limiting the possible answers to a permitted date range.

66. An apparatus for collecting the operational parameters of an employee benefit plan, the apparatus comprising:
a memory that stores executable instructions; and
a processing system that executes the instructions to:
transmit to a user a data input form comprising:
one or more questions relating to operational parameters of the employee benefit plan, at least one of the questions allowing a response comprising multiple answers; and
one or more instructions for dynamically modifying the input form based on a response comprising multiple answers; and
receive responses to at least a subset of the questions.
